(19) United States
(12) Patent Application Publication
(10) Pub. No.: US 2015/0050444 A1
(43) Pub. Date: Feb. 19, 2015

(54) Method and Apparatus for Joining a First Film Web and a Second Film Web

(71) Applicants: OVD Kinegram AG, Zug (CH); LEONHARD KURZ Stiftung & Co. KG, Furth (DE)

(72) Inventors: Thomas Bernet, Pfaffnau (CH); Fabian Arnold, Schattdorf (CH); Volker Oestreich, Illschwang (DE)

(21) Appl. No.: 14/391,624

(22) PCT Filed: Apr. 17, 2013
(86) PCT No.: PCT/EP2013/057993

§ 371 Date: Oct. 9, 2014

(30) Foreign Application Priority Data
Apr. 24, 2012 (DE) 10 2012 103 586.5

(51) Int. Cl. C09J 7/02; B44C 1/24

(52) U.S. Cl. CPC C09J 7/0242; C09J 7/0285; B44C 1/24; C09J 2467/006; C09J 2423/04; C09J 2201/122; C09J 2201/61
USPC 428/58; 428/57; 156/60; 156/272.2; 156/256; 156/277; 156/353; 156/350; 156/196

(57) ABSTRACT

Two film webs (1), (2) (in each case transfer film or laminating film) with a carrier film (11) and decorative layer (14), in particular metal layer and/or color layer (14), are to be joined to each other. Instead of using a conventional adhesive tape with cold-setting adhesive as hitherto, in the present case a hot-melt adhesive or an adhesive which can be cured using (UV) radiation is used. For example, using hot stamping, a carrier (63) with a PET layer (64) and an adhesive (65) can be applied which joins together two film webs (1, 2) which are in abutment.

The invention relates to a method and an apparatus for joining a first film web and a second film web, wherein the two film webs provide a transfer film or laminating film and comprise a carrier film and a decorative layer, wherein the decorative layer in particular is formed (covering the whole surface) as metal layer and/or color layer. The invention also relates to a film web, such as can be formed using the method according to the invention.

In the processing and use of transfer films and laminating films, several film webs must often be joined to each other in order to obtain a correspondingly longer total length (“run length”). The film web is then available preferably rolled on a roll without interruptions in the desired run length.

The longer the film web obtained in this way is, the higher the level of productivity which can be achieved when using it. Setup times or downtimes, for example accompanying a change of roll, are also reduced.

A known method for joining film webs is so-called “splicing”, in which self-adhesive tapes customary in the trade are attached manually to glue together two film webs. Laminating or transfer films (films coated on one side with a detachable transfer layer) are typically glued on the uncoated side of the film. The width of the adhesive tape is typically in the range of between 2 cm and 5 cm. The adhesive tapes have a typical thickness from the range of approx. 30 μm to 130 μm. The application of adhesive tapes to both sides is also used.

Splicing with adhesive tape is cost-effective, can be carried out with a relatively high registration accuracy of the film webs relative to each other, and the splice (the joining point or joining seam) has high strengths, in particular tensile strength in the direction of travel of the film web. The tensile strength in the direction of travel of the film web is critical as the forces arising, in particular to transport the film web rapidly, during the processing of film webs e.g. in printing machines, laminators, laminating machines, hot-stamping machines, cold-stamping machines, arise in the direction of travel.

In the stamping of individual images, these individual images or motifs (panels) are arranged in a particular layout on the film, in regular lines and tracks. As a rule, the panels to be stamped lie so close to each other that the adhesive tape typically used would lie in the region of the stamping zone, therefore also in the region of the panel to be stamped. The panels covered by the adhesive tape therefore cannot be stamped and are lost. In order to avoid stamping errors and/or dirtying of the stamping tool by the adhesive tape or by adhesive of the adhesive tape emerging at the edge of the adhesive tape, the splice is therefore detected and the film is advanced, whereby there is a loss of material and productivity is reduced. In order to make the splice detectable, a colored and usually opaque (non-transparent) adhesive tape is often used.

A disadvantage of splicing is also that, on account of the conventional adhesive tape used, the cold-setting adhesive belonging to this can be pressed out at higher pressure, for instance even within a spliced film roll, with the result that adjacent windings on the roll are stuck together and the roll can no longer be unwound. The cold-setting adhesive distributed within the roll in this way moreover makes a plurality of points on the film web dirty, which are thereby possibly no longer usable. A further disadvantage is that the relatively thick adhesive tapes which have hitherto been used lead to undesired markings and indentations in the film rolls, in particular through several layers of film, with the result that, in addition, material of the film web close to the splice can become useless for further processing.

The object of the present invention is to specify an improved method and an improved apparatus, through which the named disadvantages are reduced or prevented.

This object is achieved according to the invention by a method for joining a first film web and a second film web, wherein the two film webs provide a transfer film or laminating film and comprise a carrier film and a decorative layer (in particular a metal layer and/or color layer), wherein it is provided that the joining is carried out using an adhesive which is deactivated (or non-adhesive) in a basic state at room temperature (20° C. at atmospheric pressure of 1013 mbar), and which can be activated by the supply of heat or by the supply of radiation and is (correspondingly) activated in the method.

The decorative layer can also feature optically active microstructures, for example diffractive or refractive structures such as e.g. Kinegram®, hologram, matte structures, zero-order diffraction structures or also microprisms or microlenses, the visibility of which is increased by metal layers, metal compounds or so-called HRI layers (HRI=High Refractive Index) in particular as reflective layer. Multi-layer systems, one-color or multi-colored printed layers, layers with magnetic pigments etc. can also be used as decorative layer.

By using a hot-melt adhesive or a reactive adhesive in the present case, in particular an adhesive that can be cured by radiation, the disadvantage in the state of the art, that the adhesive can be pressed or squeezed out under pressure, is avoided. A hot-melt adhesive also effects a particularly good adhesion, with the result that the tensile strength required for a film web can be achieved at the adhesive joint using a comparatively small amount of material. The adhesive which can be cured by radiation is preferably an adhesive which can be cured using UV rays, however other rays (blue light, ion beams etc.) can in principle also be used for curing. All single-component and multi-component reactive adhesives can be used as reactive adhesive. Hot-melt adhesives or UV-curable adhesives of this kind are solid and non-adhesive at room temperature, with the result that the mentioned pressing or squeezing out of adhesive substance is largely avoided and even the smallest amount of adhesive residue protruding is not adhesive and did not cause any dirtying within the rolled-up film web and/or during processing of the film web (hot stamping, cold stamping).

The invention is based on the realization that, when the first and second film webs are joined according to the invention, there is no impairment of these even if they are formed as a hot-stamping film. In particular, it is also possible to stamp in the region of a joining point between the ends of the film webs made of the lowest-lying film web or at a seam point made of both film webs without the presence of the joining point being recognizable to an excessive extent on the stamped objects. It has therefore been demonstrated that the quality of a stamping made of a region of the film web with a joining point is sufficient for very many fields of use, even in comparison with a stamping made of a region of the film web without a joining point.

In a preferred embodiment of the invention, the adhesive is provided on a separate (different from the film webs) tape-like or otherwise suitably shaped carrier. The technique of using an adhesive tape is drawn on here even if a hot-melt adhesive or radiation-curable adhesive is used. Providing the adhesive on a carrier is a particularly convenient method because the adhesive can be stored together with the carrier.

The tape-like carrier here can preferably be transparent and in particular can consist of a material which comprises polyethylene terephthalate (PET) or polyester. Further possible materials which come into consideration for the tape-like carrier and also for the film webs are: polyethylene terephthalate (PET), BOPP films (BOPP=biaxially oriented polypropylene), PET-G, PVC, PC, PP, PS, PEN, ABS, synthetic paper or a laminate of two or more such layers (PET-G=PET with glycol; PVC=polyvinyl chloride; PC=polycarbonate; PP=polypropylene; PS=polystyrene; PEN=polyethylene naphthalate; ABS=acrylonitrile butadiene styrene copolymer). Because of the transparency of the tape-like carrier, even if the carrier should still be present on the composite film web, a pattern can be recognized through the carrier in order to be able to thus stamp with registration accuracy even in the region of the joining point between the film webs. If cold-stamping films are joined to each other as film webs, light of sufficient strength, e.g. UV radiation, can pass through the transparent tape-like carrier during cold stamping.

PET is particularly suitable for the tape-like carrier because the film webs also typically comprise a carrier made of PET.

This can also be formulated such that the coefficients of expansion of a tape-like carrier, to be applied at the joining point between the film webs, and the film webs are to differ from each other by not more than 50%, preferably not more than 20% and particularly preferably not more than 10%, so that a joining point has a particularly high tensile strength.

In a further preferred embodiment the tape-like carrier has a thickness between 5 μm and 50 μm, preferably of between 8 μm and 20 μm, particularly preferably of between 10 μm and 15 μm. The adhesive layer thereon here is between 1 μm and 5 μm thick, preferably between 2 μm and 3 μm thick.

In the case of the small thicknesses named (for instance a thickness of 12 μm with an adhesive layer of 3 μm, and 15 μm in total) the tape-like carrier is hardly disruptive during stamping even if it is part of the finished total film web.

In the method, in which the adhesive is provided on a carrier web, different variants are possible:

In a first variant both film webs are cut and positioned, before the tape-like carrier is attached, in such a way that they abut against each other (are brought into abutment), and that the tape-like carrier is placed overlapping the ends of the film webs which abut against each other and the adhesive is then activated, with the result that the tape-like carrier adheres to both film webs.

Here the technique of using a conventional adhesive tape with cold-setting adhesive is drawn on but, because of the present use of a hot-melt adhesive or a radiation-curable adhesive, a particularly good adhesion is ensured while using a comparatively small amount of material. For example, an improved adhesion can be guaranteed even in the case of particularly thin tape-like carriers (see the above-named low values for the thickness).

In this variant, the two film webs are preferably first laid overlapping each other, then a cut is made through both film webs in the region of the overlap (wherein the cut is made in particular using a knife, a razor blade, a cutting roller, scissors, a cutting die, using a laser or ultrasound), and after the cut has been made, the cut-off ends of the film webs forming in this way are removed.

By cutting the film webs before the joining, a defined joining point can in particular be created more or less without a seam. Where appropriate it is even possible here to ensure registration accuracy in the region of the joining point, with the result that the join as such is no longer discerned at all. By registration accuracy, also called register accuracy, is meant a relative positional accuracy in particular of the joining points relative to each other. The positional accuracy is to vary within a very low tolerance, usually in the two-digit, at most three-digit, micrometre range. The term is derived from the term “registration” or “registration mark”, which means an optical marking by means of which a deviation from the above-named tolerance can be particularly well recognized optically. For example, registration marks can be two overlapping circles, crosses, triangles or combinations thereof. Registration marks are also called register marks.

By modifying the first variant, the film webs can be positioned, before the tape-like carrier is attached and after cutting, in such a way that they overlap slightly, by a few millimetres (e.g. between 0.5 and 4 mm). In this case, the tape-like carrier is placed on the overlapping ends of the film webs further overlapping and the adhesive is then activated. During activation, for example by hot stamping the tape-like carrier, not only is the adhesive on the tape-like carrier activated but also any hot-melt adhesive present from the film web lying beneath. It is advantageous that the overlapping film web end of the lower overlapping film web end is glued to the adhesive layer of the upper overlapping film web end.

In the first variant also in the named modification, a sheet-like element coated with silicone and with a very low surface adhesion, in particular a silicone-coated (sheet of) paper, is furthermore preferably laid under the two film web ends after cutting and before positioning. This is advantageous in particular if a hot-melt adhesive is used which is therefore activated by the supply of heat and pressure. The element or paper coated with silicone then prevents the assembled film web from adhering to a substrate. Preferably, in the case of the first variant named previously (and also in the further variants named subsequently) the activation is carried out using a hot-melt adhesive using a translationally movable lifting stamp, a rotationally movable heated roller or a translationally and rotationally movable roller stamp. These tools can be used particularly advantageously.

In a second variant of the method, in which a carrier tape with adhesive is used, the tape-like carrier has adhesive on both sides. The film web ends are arranged overlapping each other and the tape-like carrier is laid between the film web ends in the region of the overlap. Where appropriate, before the carrier is positioned between the film web ends a protection to protect the adhesive layer, for example a silicone layer, is removed from the carrier. The adhesive is then activated on both sides of the carrier, with the result that the tape-like carrier adheres between the two film web ends, with the result that these are joined to each other. This technology ensures a very reliable adhesion and a high tensile strength.

In a third variant of the embodiment with a carrier tape having adhesive only on its underside, the film web ends are arranged overlapping each other and the tape-like carrier is laid between the film web ends in the region of the overlap. With the aid of a hot-stamping tool (lifting stamp, heated roller, roller stamp etc.) the decorative layer of the first film web is then transferred to the tape-like carrier, in particular its upper side, and the adhesive detaches from the underside of the tape-like carrier and is transferred to the second film web. The tape-like carrier is then taken out of the overlap and a hot-stamping tool (or alternatively UV radiation or other high-energy rays) is then used again to glue the film web ends to each other in the region of the overlap and thus to join them to each other. The side of the first film web from which the decorative layer has been removed faces the side of the second film web provided with adhesive. The adhesive transferred to the second film web is then activated, wherein the first film web in the overlap without decorative layer adheres firmly to the second film web in the region of the overlap with the aid of the adhesive.

In this way only one decorative layer is obtained at the joining point, namely that of the lowest-lying film web. As a result, when the film web is a cold-stamping film, the cold stamping can be carried out more easily because it is not necessary for (UV) light to penetrate through the upper decorative layer and thereby be weakened too much.

There is also an embodiment of the invention in which a carrier tape with adhesive is dispensed with. Here, the adhesive is applied to a film web end of the second film web using a doctor blade, spraying, spreading, printing or other means in liquid or solid form. Then, preferably after the decorative layer has been peeled off the film web end of the first film web, a film web end of the first film web is laid overlapping the film web end of the second film web and the adhesive is activated, with the result that the film web ends adhere to each other in the region of the overlap and thus the film webs are joined to each other. The side of the first film web with the decorative layer removed faces the side of the second film web provided with adhesive.

In a further alternative embodiment of the invention the adhesive is provided as outer layer in the film web. The film web ends of the first and of the second film web are arranged overlapping each other in such a way that the layer with the adhesive of the first film web faces the side of the second film web facing away from the decorative layer of the second film web. With the aid of a hot-stamping tool (lifting stamp, heated roller, roller stamp) the adhesive of the first film web is then activated, with the result that the film web ends adhere to each other in the region of the overlap. The decorative layer of the second film web then represents the usable decorative layer of the composite film web.

The advantage perceived here is that on a film web, in particular the first film web, an adhesive layer can already be present in any case. Any additional element such as a carrier tape for example can thereby be dispensed with. The joining point is only recognizable through the overlap between the film web ends.

As already stated, the method according to the invention in all embodiments is suitable in particular for the case where the film webs which are to be joined to each other provide a hot-stamping film or a cold-stamping film.

In the preferred design of the method in all embodiments, during the joining of the film webs in each case one pattern or marking located on both film webs is taken into account, in order that the respective patterns or markings are arranged with registration or positional accuracy relative to each other. In this way, continuity of the pattern or markings over the joining point between the two film webs can be ensured. Known techniques for detecting such patterns or markings can be drawn on, e.g. using optical sensors and cameras or by direct pattern detection for example of registration marks or register marks.

The method according to the invention can be carried out automatically or semi-automatically or manually during the respective processing or use of the film web, e.g. in a machine for applying films or in a machine for producing films. It is advantageous for this if the running speed of the film web within the respective machine is slowed in such a way that the film webs can be joined according to the invention. The running speed is preferably only slowed, but a complete stop is avoided, with the result that a continuous processing of the film web can take place in spite of the splicing. After the splicing or joining of the film webs, acceleration back to the original running speed can take place. Alternatively, it is also possible however to carry out the method according to the invention with a stationary, i.e. stopped, film web or, in a further alternative, with the respective machine at unslowed, i.e. full, running speed.

The object is also achieved by an apparatus for carrying out the method. This has means controlled by control equipment for moving and/or clamping and/or cutting film web ends of at least one of two film webs and equipment for detecting the position of patterns and/or markings, wherein the control equipment is configured to effect the movement, clamping and/or cutting as a function of a detected position. The detection of the position can be carried out optically.

The apparatus according to the invention therefore makes it possible to carry out the method in the preferred variant, such that registration accuracy is also ensured in the region of the joining point between the film webs.

The apparatus according to the invention can preferably be arranged on film-winding equipment, for example in a printing machine or laminator or laminating machine or hot-stamping machine or cold-stamping machine. There, film webs are fed to the corresponding machine for further processing. It is advantageous to carry out the joining of the film webs there such that the further processing procedure is disrupted as little as possible and that this processing procedure needs to be interfered with as little as possible. It is likewise particularly easy to regulate the speed of the film-winding equipment in this way. Thus, using simple means, the film-winding equipment can be slowed or stopped to make it easier to join the film webs and can be accelerated or started again just as easily after the film webs have been joined. This takes place, for example, using an electronic motor control unit which is present in any case and, where appropriate, can also control other drives or processing modules of the respective machine to synchronize the changing processing speed. Likewise, the apparatus according to the invention can be used in a machine for producing films to match the run length of the films produced there to specific requirements. Thus e.g. individual film webs from different, separate production runs can be joined to form a combined film web on a combined roll. This can take place in particular so as to make further processing of the film web easier.

The object is further achieved by providing a film web which, in a first aspect, comprises a carrier film and a decorative layer (in particular metal layer and/or color layer) and is composed of at least two partial film webs which are joined to each other at two respective partial film web ends by means of an adhesive which is activated during the joining by the supply of heat or by the supply of radiation (ultraviolet light, blue light, ions etc.).

Such a film web can be obtained using the method according to the invention.

The object is also achieved in a second aspect by a film web which comprises a carrier film and a decorative layer (in particular metal layer and/or color layer) and is composed of at least two partial film webs which are joined to each other at two respective partial film web ends by an (in particular transparent) tape, preferably made of a material which comprises polyethylene terephthalate (PET), at a thickness of between 5 μm and 100 μm, preferably between 10 μm and 1.5 μm. The last-named film web can, in particular, comprise the properties of the first-named film web.

In the case of the film web according to the second aspect, a relatively thin transparent tape is provided in the joining region between the partial film webs. This is made possible in particular by using the method according to the invention which is based on this embodiment. In particular, in conjunction with the first aspect (hot-melt adhesive or radiation-curable adhesive) a sufficient tensile strength can here be provided at the joining point.

Preferred embodiments of the invention and reference to the drawings are described in more detail below, in which

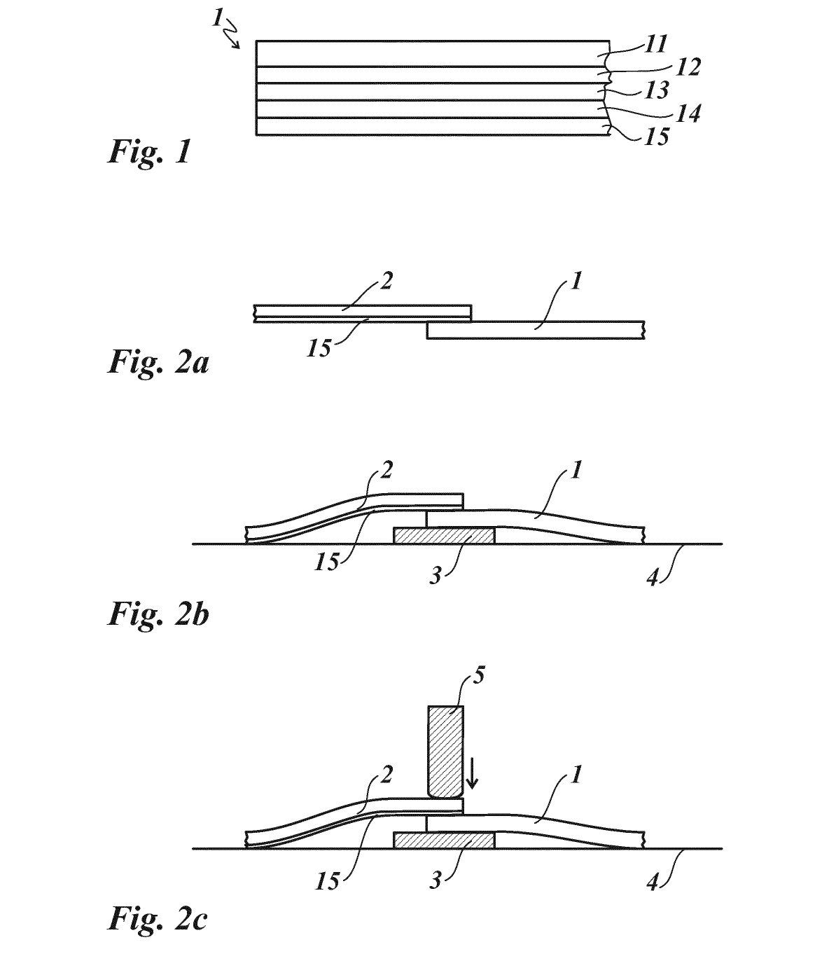

FIG. 1 illustrates the structure of a film web which is to be joined to a similar film web to form an aggregate film web;

FIGS. 2a to 2c serve to explain the steps of a first embodiment of the method according to the invention;

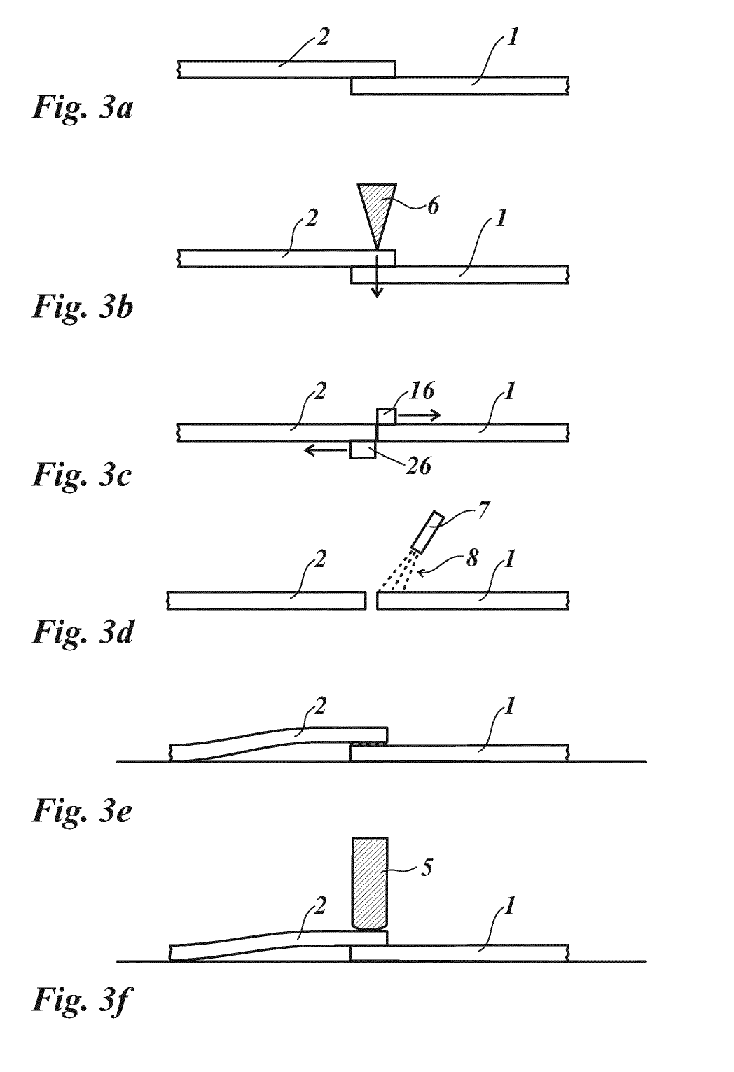

FIGS. 3a to 3f serve to explain the steps of a second embodiment of the method according to the invention;

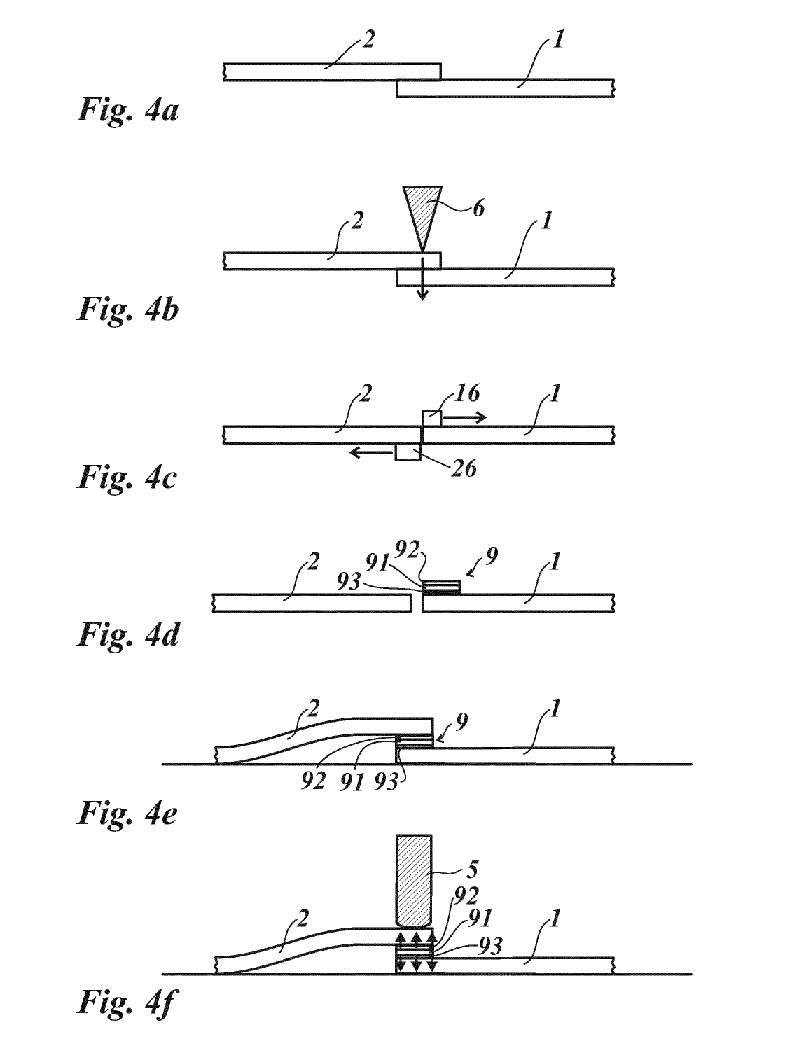

FIGS. 4a to 4f serve to explain the steps of a third embodiment of the method according to the invention;

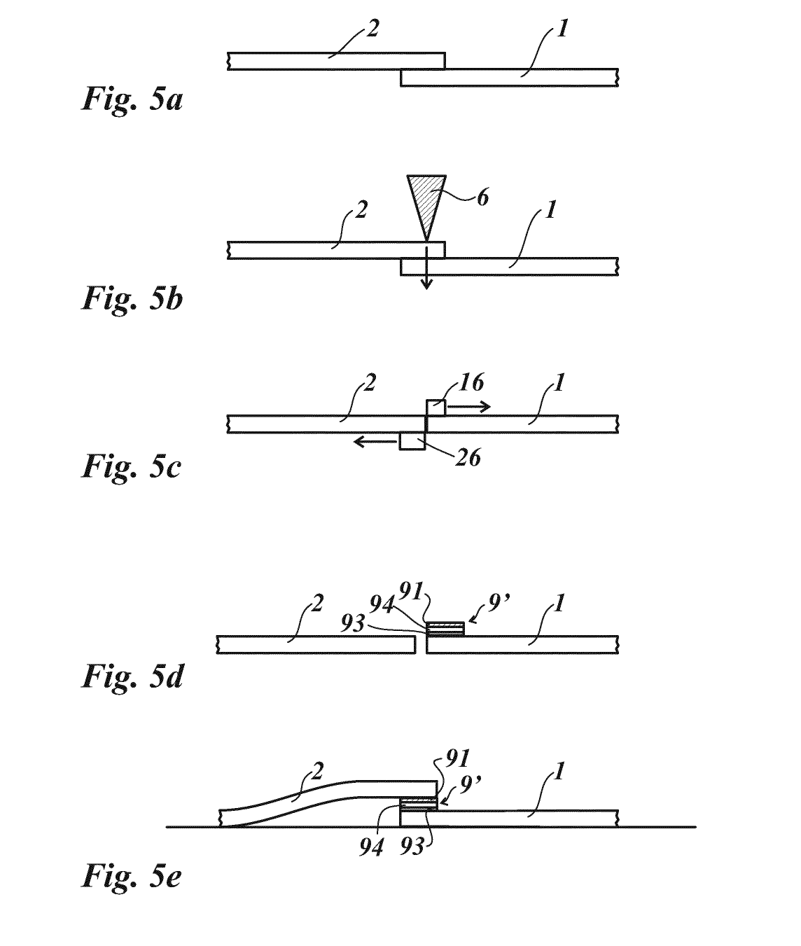

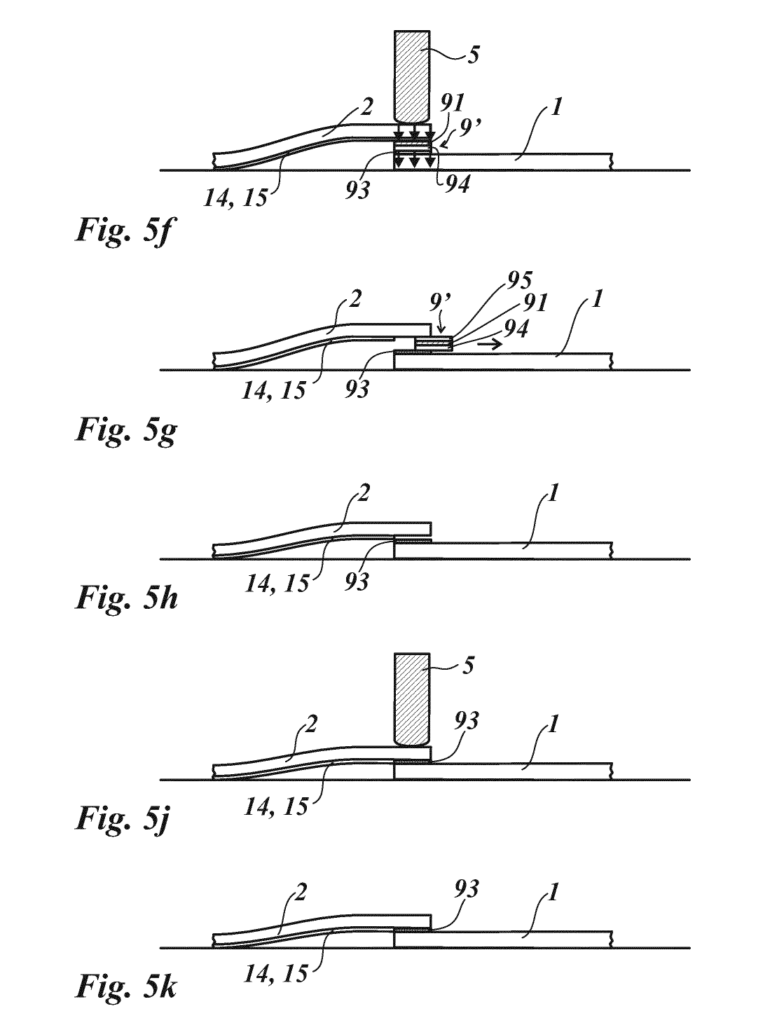

FIGS. 5a

to 5k serve to explain the steps of a fourth embodiment of the method according to the invention;

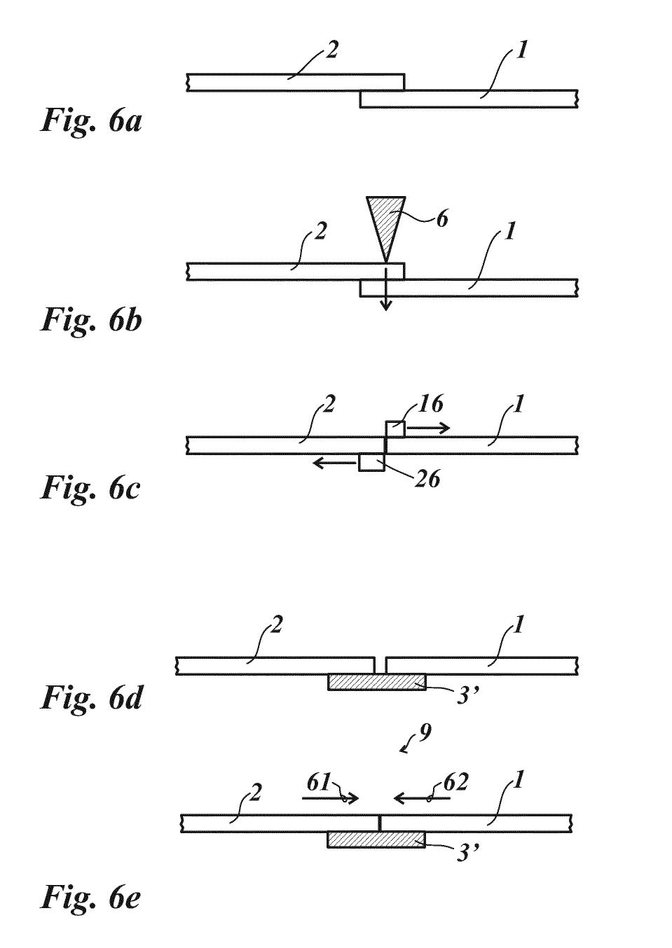

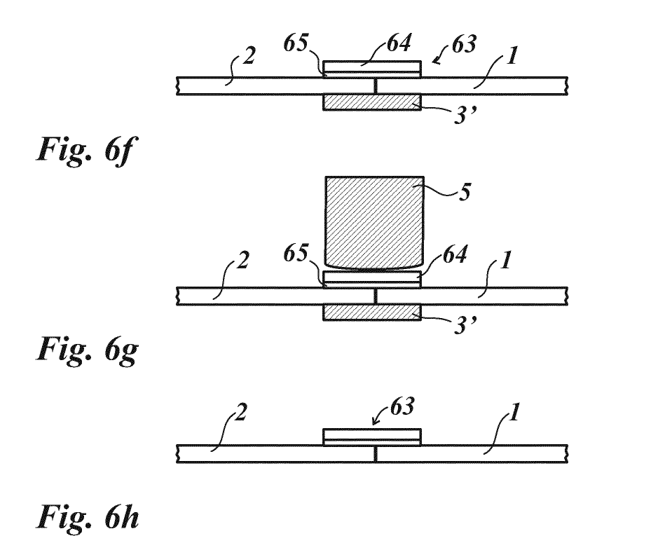

FIGS. 6a to 6h serve to explain the steps of a fifth embodiment of the method according to the invention;

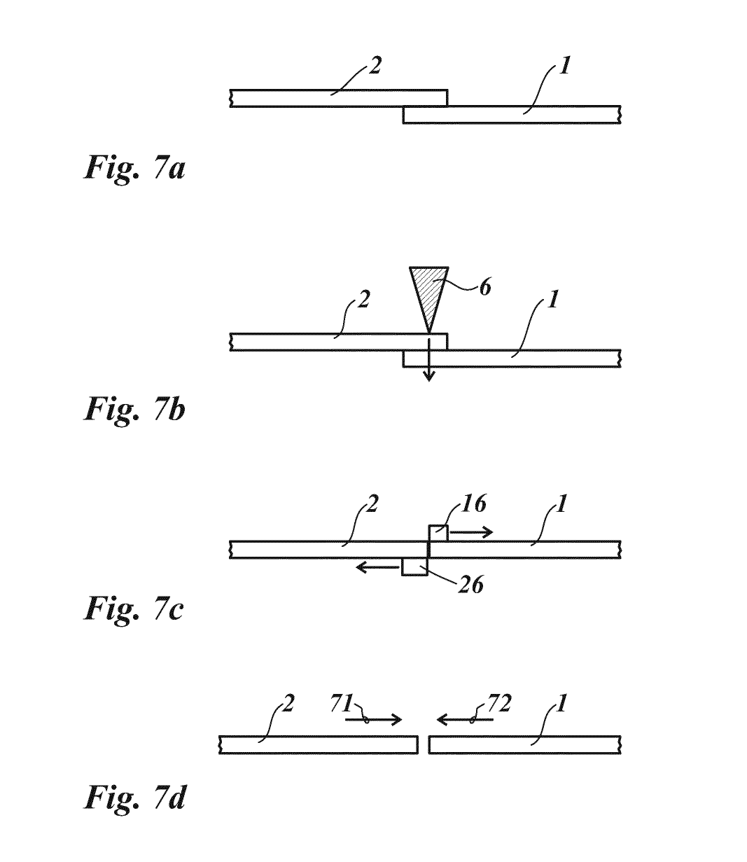

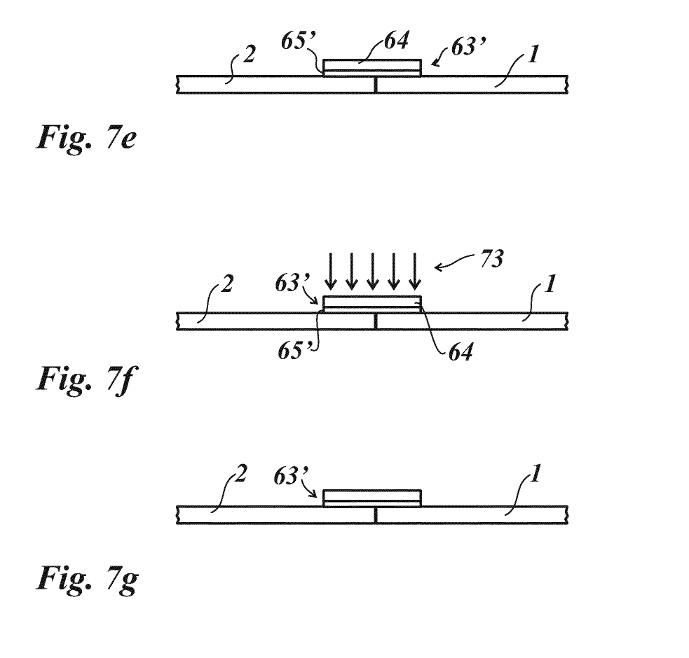

FIGS. 7a and 7g serve to explain the steps of a sixth embodiment of the method according to the invention;

A film web labelled 1 throughout is to be joined to a similar film web, labelled 2 in the following, to form an aggregate film web.

The film webs each have a layer structure, as explained in FIG. 1:

A carrier film 11, e.g. polyethylene terephthalate (PET), is located on a respective upper side at a layer thickness of between 5 μm and 500 μm.

Located on the carrier film 11 there is a detachment layer 12 which serves to make it possible to detach the further layers 13, 14, 15 from the carrier film 11 more easily. The detachment layer consists, for example, of a wax. The layer 13 is a protective layer and consists, for example, of acrylic lacquer or acrylic lacquer mixture, thermally drying and/or UV-cured. A metal layer 14, e.g. of aluminum or chromium or copper, follows the protective layer 13. The outermost, lowest-lying layer 15 is an adhesive layer of a preferably heat-activatable adhesive, if the film web 1 is to be a hot-stamping film. The layer 15 is a so-called adhesion-promoter or primer layer made of a preferably heat-activatable adhesive which can interact with a (UV-curable) adhesive, if the film web 1 is a cold-stamping film.

In a first embodiment of the method the two film webs 1 and 2 are firstly laid with their film web ends overlapping each other (FIG. 2a). A paper 3 coated with silicone, with the silicone-coated side uppermost, is laid under the film web ends such that the film web ends do not adhere to the substrate (FIG. 2b). (This step is optional.)

The film web ends are now clamped and fixed to the substrate 4. This can be carried out, for example, with the aid of a vacuum if the substrate 4 has small perforations (not shown in the figure) through which the film web ends are sucked in. The film web ends can also be held fast at the corners or edges which are lateral with respect to their longitudinal extension and clamped using a clamping apparatus such as a tie beam, for example. The clamping and fixing to the substrate can further also be carried out using electrostatic forces. Finally, vacuum, tie beam or electrostatic forces can also be used in combination with each other.

It is important that, in the arrangement according to FIG. 2b, the film ends lie or are held so closely that, when an external force is applied, as provided subsequently, they do not change their position, or do so only insignificantly. In the following step (FIG. 2c), a hot-stamping tool 5, shown here as a lifting stamp, alternatively a heated roller or a roller stamp, is pressed against the upper film web 2. As is customary with hot stamping, the hot-stamping tool here is heated and its heat is transferred to the upper film web 2, with the result that the adhesive layer 15 (or optionally in the case of a cold-stamping web the primer layer 15) is activated, i.e. becomes adhesive, with the result that the two film web ends of the film web 1 and 2 are glued to each other and adhere to each other.

The hot-stamping tool is brought to a temperature of 80° C. to 140° C., e.g. of 110° C., and applied for a period of 1 to 2 seconds. It is important that only the adhesive layer 15 is activated, and that, for instance, the carrier film 11 is not caused to melt or shrink. Before the hot stamping it is possible to pre-heat the stamping point on the film web and/or the hot-stamping tool using hot air or radiant heaters in order to be able to apply the hot-stamping tool for only a relatively short time during the creation of the join. The upper film web is used in its capacity as a stamping film to produce the join between the upper film web 2 and the lower film web 1.

The silicone paper 3 is then removed and there is a good join between the two film webs 1 and 2. The tensile loading is guaranteed in particular with a sufficiently thick carrier film 11 (between 12 and 20 μm, e.g. 19 μm thick) and a sufficient quantity of adhesive in the adhesive layer 15. For example, the adhesive layer 15 can be more than 5 μm thick (e.g. 8 μm). This corresponds to the same number of g/m², thus for example 8 g/m².

The first embodiment of the method in the present case has the advantage that, in a subsequent hot stamping, the embossing tool is not made dirty.

In a second embodiment of the method, according to FIG. 3a the film web ends of the film web 1 and 2 are firstly overlapped again. The film web ends are then clamped in the manner described above and fixed to the substrate. As shown in FIG. 3b, a cutting tool 6 is then applied, for example a knife, a razor blade, a cutting roller, scissors, a cutting die. Alternatively, a laser beam or ultrasound waves could also be applied. It is also possible to cut at a particular blade angle of the cutting edge, the laser beam etc. which is not equal to 90° relative to the surface of the film web, with the result that a diagonal cut end forms at the cutting point.

In particular, the two film web ends of the film webs 1 and 2 are cut simultaneously, with the result that the film web ends are then in abutment. The remaining film web end pieces 16 and 26 are removed, see FIG. 3c. In the case of a diagonal cut end, when placed in abutment the two inclined surfaces interlock.

Adhesive 8 is then sprayed onto one film web 1, which later functions as the lower film web 1, using a spraying tool 7. Other application options such as using a doctor blade, spreading, printing are also possible. The lower layers can be removed, i.e. peeled off, from the other film web 2 manually, e.g. using an adhesive tape (optional). If the film web end of the film web 2 is now laid on the film web end of the film web 1 according to FIG. 3e and a hot-stamping tool 5 is then applied as shown in FIG. 3f, the previously sprayed-on adhesive 8 is activated and the two film webs 1 and 2 are glued to each other.

In particular, if the transfer layers of the film web end of the film web 2 are removed manually, there is only one metal layer (as part of the decorative layer of the film web 2) on the finished film web in the region of the joining point, with the result that, in particular, UV-illumination during cold stamping in the splice region is made easier.

In a third embodiment of the method, at first the same steps are carried out as in the second embodiment of the method, FIGS. 4a to 4c correspond to FIGS. 3a to 3c. In the present case, however, the adhesive is not applied in liquid form but in solid form using a carrier 9, see FIG. 4d. The carrier 9 can have a base body 91 on both sides of which adhesive layers 92 and 93 with e.g. a thickness of between 1 μm and 6 μm are applied. The adhesive layers can, for their part, be covered with a protective layer, which has, however, already been removed in FIG. 4d. Such a protective layer can be a thin silicone paper layer, for example.

In the situation according to FIG. 4d, the carrier 9 adheres to the film web 1 as a result of the presence of the adhesive layer 93. The upper adhesive layer 92 is exposed. If the film web 2 is now placed with its film web end on the carrier 9, according to FIG. 4e, by means of the adhesive layer 92 the film web 2 can also adhere to the carrier 9 and thus to the film web 1. This is also carried out in the present case using a hot-stamping tool 5, by means of which the adhesive in the adhesive layers 92 and 93 is activated, cf. the arrows in FIG. 4f.

In a fourth embodiment of the method according to the invention, in a modification of the embodiment according to FIGS. 4a to 4f, at first the process is as has already been described in relation to FIG. 3a to FIG. 3c. However, a carrier 9′ is now used which has a base body 91 on which a lower adhesive layer 93 is located by means of which the carrier 9′ adheres to the film web 1. However, there is furthermore located on the base body 91 a silicone coating 94 between the carrier 9′ and the adhesive layer 93. Here too, according to FIG. 5e, the film web 2 is placed with its end on the carrier 9′. If a hot-stamping tool 5 is now applied (FIG. 5f), on the one hand the adhesive in the adhesive layer 93 is activated, see the lower arrows pointing downwards. However, at the same time, the transfer layer 14, 15 of the film web 2 is stamped on the upper side of the carrier 9′, see the upper arrows pointing downwards. As can be seen in FIG. 5g, the carrier 9′ can then be removed. The adhesive 93 has now detached from this carrier 9′, but the transfer layer 95 of the film web end of the film web 2 is now located on the upper side of the carrier 9′ instead.

After the carrier 9′ has been removed, the film web 2 can now be laid with its film web end on the film web 1, see FIG. 5g, and when the adhesive layer 93 is subsequently activated using a hot-stamping tool 5 (FIG. 5h), an adhesive bond is formed according to FIG. 5k.

In this embodiment it is guaranteed to an increased degree that only one metal layer is present in the region of the joining point (splice region), namely the metal layer of the transfer layer of the lower film web 1. In particular during cold stamping, it is thereby also possible to carry out UV-activation of the adhesive of the lower film web 1 through the metal layer. When the lower film web 1 is hot stamped, it is ensured that the hot-melt adhesive of the lower film web 1 does not make the hot-stamping tool dirty.

In a fifth embodiment of the method, at first the process according to FIGS. 6a to 6c is as has been explained in relation to FIGS. 3a to 3c. A paper 3′ coated with silicone is now laid under the cut film web ends of the film webs 1 and 2. This prevents the film web ends 1 and 2 from adhering to the substrate. According to FIG. 6e, see arrows 61 and 62, the film webs 1 and 2 are now optionally repositioned such that the gap between them is minimal, less than 1 mm. Unlike in the embodiments described hitherto, in the present fifth embodiment an overlap is no longer provided between the film web ends, but the film web ends abut against each other, are “in abutment”.

According to FIG. 6f, a hot-melt adhesive tape 63 is now positioned over the cutting point or point of abutment.

The hot-melt adhesive tape 63 comprises a PET carrier 64 and an adhesive layer 65. The PET carrier 64 is transparent and has a thickness of between 5 and 20 μm, e.g. of 12 μm. In the present case, the adhesive layer 65 comprises a thermally activatable adhesive and is approx. 3 μm thick (between 2.5 and 3.5 μm). The hot-melt adhesive tape 63 is thus approx. 15 μm thick in total. A hot-stamping tool 5 (FIG. 6g) is then applied and the adhesive in the adhesive layer 65 is activated. As a result, the hot-melt adhesive tape 63 now sticks fast to the film webs 1 and 2. After the silicone paper 3′ has been removed, a firm join is thus obtained according to FIG. 6h between the film webs 1 and 2 by means of the hot-melt adhesive tape 63 which becomes an integral part of the total film web.

By avoiding an overlap, it is made possible to an increased degree also to stamp in the region of the joining point (splice region). This is true to a particular degree for cold stamping. Because of the small thickness of the hot-melt adhesive tape 63 and because there is no overlap of the film webs 1 and 2 by positioning them “in abutment”, the splice point on the finished film web is also hardly noticeable in a disruptive manner.

In a sixth embodiment of the method, at first the process is as in the fifth embodiment, however in this case underlaying a silicone paper 3′ is dispensed with, and the repositioning according to FIG. 7d takes place without such a silicone paper, see arrows 71 and 72, already after the film webs 1 and 2 are cut off at their ends.

Here too, an adhesive tape 63′ (see FIG. 7e) is laid on the cutting point, in the present case this adhesive tape comprises the same PET carrier 64 as the adhesive tape 63 according to FIG. 6f, however in this case with an adhesive 65′ which can be cured with UV radiation.

Correspondingly, in step 7f, instead of a hot-stamping tool, UV radiation is radiated in, see arrows 73, and a firm bond is created between the film webs 1 and 2, see FIG. 7g.

In all of the named methods, the use of suitable detection means, e.g. optical detection means such as a camera for instance, can ensure that the film webs 1 and 2 are joined to each other with registration accuracy such that a pattern located on the film webs 1 and 2 continues virtually uninterrupted over the splice point.

Here, either the pattern located on the film webs is detected directly, for example by the optical detection means, and appropriate positioning of the overlap, in the second to sixth methods in particular for setting the cutting point, ensures that the remaining parts of the film webs 1 and 2 lie with registration accuracy relative to each other. Registration accuracy means that patterned regions corresponding to each other are arranged in each case at the same distances from each other, even over the splice point.

Instead of a direct detection of a pattern on the film webs, register marks can also be provided on them; these are deliberately set marks which serve to position the film web in a further processing step, and are taken into account in the present case when joining two film webs 1 and 2 to each other. Register marks can, inter alia, also be present in the form of perforations which are then detected by mechanical equipment or also optically.

In the corresponding apparatus, the detection equipment sends measurement signals to control equipment and this then appropriately controls other equipment or means such that the film web ends of the two film webs 1 and 2 are arranged with registration accuracy relative to each other after the join has been produced. For example, these can be means for moving the film web ends, and the movement is carried out as a function of signals obtained by the equipment for detecting the position. In the same way, the film web ends can also, alternatively or in addition, be appropriately clamped, by clamping means, and finally the film web ends can also be cut by cutting means as a function of the measured values obtained, in such a way that the patterns on the film webs come to lie with registration accuracy relative to each other.

With the exception of the sixth embodiment, the joining is carried out here using a hot-melt adhesive.

There are various starting points which the composition of this hot-melt adhesive can have (Fp=flashpoint; Tg=glass transition temperature):

| | | Proportions by |
|---|---|---|
| | | weight |
| 1^{st} Composition | | (in 7500) |
| Toluene | | 2000 |
| Acetone | | 2100 |
| High molecular weight ethyl | Tg 60° C. | 300 |
| methacrylate | | |
| Methacrylate copolymer | Tg 40° C.-80° C. | 700 |
| Thermoplastic polyvinyl acetate | Tg 80° C.-83° C. | 200 |
| Ethanol | | 2100 |
| Highly dispersed silica | | 100 |

| | Proportions by |
|---|---|
| 2^{nd} Composition | weight (in 1030) |
| Methyl ethyl ketone | 280 |
| Toluene | 350 |
| PVC/PVAC copolymer (Fp 80° C.) | 210 |
| Thermoplastic polyurethane | 130 |
| (density = 1.18 g/cm³) | |
| Silica, hydrophobized | 60 |
| (particle size approx. 10 μm) | |

| | Proportions by |
|---|---|
| | weight |
| 3^{rd} Composition | (in 1000) |
| Methyl ethyl ketone | 380 |
| Toluene | 400 |
| Ethylene vinyl acetate terpolymer | 60 |
| (Fp 66° C.) | |
| Ketone resin (Fp 85-90° C.) | 80 |
| Vinyl chloride/vinyl acetate | 70 |
| copolymer (Fp 80° C.) | |
| Silicon dioxide | 10 |

| | Proportions by |
|---|---|
| | weight |
| 4^{th} Composition | (in 1000) |
| Methyl ethyl ketone | 550 |
| Ethyl acetate | 175 |
| Cyclohexanone | 50 |
| Polyurethane resin (Fp >200° C.) | 100 |
| Polyvinyl chloride terpolymer | 120 |
| (Tg = 90° C.) | |
| Silicon dioxide | 5 |

It is common to all of the named embodiments of the method that the actual transfer layer is not impaired or in any case only insignificantly impaired even in the splice region by the creation of the join, with the result that stamping can be carried out even in the splice region.

1. A method for joining a first film web and a second film web, wherein the two film webs provide a transfer film or laminating film and comprise a carrier film and a decorative layer,
wherein the joining is carried out using an adhesive which is deactivated in a basic state at room temperature and can be activated by the supply of heat or by the supply of radiation and is activated in the method.

2. A method according to claim 1, wherein the adhesive is provided on a separate tape-like carrier.

3. A method according to claim 2, wherein the tape-like carrier is transparent and consists of a material which comprises polyethylene terephthalate (PET).

4. A method according to claim 2, wherein the tape-like carrier has a thickness of between 5 μm and 100 μm and the adhesive layer thereon is between 1 μm and 5 μm thick.

5. A method according to claim 2, wherein both film webs are cut and positioned, before the tape-like carrier is attached, in such a way that they abut against each other, and that the tape-like carrier is placed on the ends of the film webs which abut against each other and the adhesive is then activated, with the result that the tape-like carrier adheres to both film webs.

6. A method according to claim 5, wherein the two film webs are laid overlapping each other and a cut is made through both film webs in the region of the overlap, in particular using a knife, a razor blade, a cutting roller, scissors, a cutting die, using a laser or ultrasound, and wherein the cut-off film web ends forming in this way are removed.

7. A method according to claim 5, wherein a sheet-like element coated with a silicone-coated sheet of paper, is laid under the two film web ends after cutting and before positioning.

8. A method according to claim 2, wherein the tape-like carrier has adhesive on both sides and the film web ends are arranged overlapping each other and the tape-like carrier is laid between the film web ends in the region of the overlap and then the adhesive is activated, with the result that the tape-like carrier adheres between the two film web ends.

9. A method according to claim 2, wherein the film web ends are arranged overlapping each other and the tape-like carrier is laid between the film web ends in the region of the overlap and with the aid of a hot-stamping tool the decorative layer of the first film web is transferred to the tape-like carrier and the adhesive detaches from the tape-like carrier and is transferred to the second film web, that then the tape-like carrier is taken out and then a hot-stamping tool or radiation is applied again, with the result that the film web ends adhere to each other in the region of the overlap.

10. A method according to claim 1, wherein the adhesive is applied to a film web end of the second film web using a doctor blade, spraying, spreading, printing or other means in liquid or solid form and then a film web end of the first film web is laid overlapping the film web end of the second film web and the adhesive is activated, with the result that the film web ends adhere to each other in the region of the overlap.

11. A method according to claim 1, wherein adhesive is provided as outer layer in the first film web and the film web ends of the first film web and of the second film web are arranged overlapping each other, with the result that the layer with the adhesive faces the second film web, and that the adhesive is activated with the aid of a hot-stamping tool, with the result that the film web ends adhere to each other in the region of the overlap.

12. A method according to claim 1, wherein the activation is carried out using a translationally movable lifting stamp, a rotationally movable heated roller or a translationally and rotationally movable roller stamp as hot-stamping tool.

13. A method according to claim 12, wherein, before the activation, the hot-stamping tool and/or a stamping point on the film web provided for exposure to the hot-stamping tool is pre-heated using hot air or radiant heaters.

14. A method according to claim 1, wherein the film webs provide a hot-stamping film or a cold-stamping film.

15. A method according to claim 1, wherein during the joining of the film webs in each case at least one pattern or marking located on both film webs is taken into account, in order that the respective patterns or markings are arranged with registration accuracy relative to each other.

16. An apparatus for carrying out the method according to claim 1, with means controlled by control equipment for moving and/or clamping and/or cutting film web ends of at least one of two film webs and with equipment for optically detecting the position of patterns and/or markings, wherein the control equipment is configured to effect the movement, clamping and/or cutting as a function of a detected position.

17. A film web, comprising a carrier film and a decorative layer and composed of at least two partial film webs which are joined to each other at two respective partial film web ends by means of an adhesive which is activated during the joining by the supply of heat or by the supply of radiation.

18. Film web, preferably according to claim 17, wherein the decorative layer comprises a metal layer and/or color layer, and composed of at least two partial film webs which are joined to each other at two respective partial film web ends by transparent, tape made of a material which comprises polyethylene, at a thickness of between 8 and 20 μm.
